(19) United States
(12) Patent Application Publication
(10) Pub. No.: US 2007/0292831 A1
(43) Pub. Date: Dec. 20, 2007

(54) MICROPHONE TYPE MUSIC ACCOMPANIMENT PLAYING (KARAOKE) SYSTEM WITH BACKGROUND IMAGE SELECTING FUNCTION

(76) Inventor: Kyung Ho Lee, Seoul (KR)

Correspondence Address: LADAS & PARRY LLP, 224 SOUTH MICHIGAN AVENUE, SUITE 1600, CHICAGO, IL, 60604, US

(21) Appl. No.: 11/753,820

(22) Filed: May 25, 2007

(30) Foreign Application Priority Data
May 30, 2006 (KR) 10-2006-0048559

(51) Int. Cl. G09B 5/00

(52) U.S. Cl. 434/307 A

(57) ABSTRACT

There is provided a microphone type music accompaniment playing (karaoke) system including: a memory section for storing a plurality of still and motion pictures; and a controller for, in Auto mode, combining the stored still and motion pictures of the memory section with each music accompaniment and sending the still or motion pictures selected in combination with the music accompaniment as a background image to an external display panel, or, in Select mode, sending both a music accompaniment signal and one of the still or motion pictures of the memory section as selected by a user as a background image to the external display panel. The microphone type music accompaniment playing (karaoke) system provides, in combination with a user' selected song, images of the original singer of the song and the song-related background images, thus fascinating users and greatly enhancing the demand for music accompaniment playing (karaoke) equipment.

### CROSS-REFERENCE TO RELATED APPLICATION

This application claims the benefit of Korean Patent Application No. 2006-48559, filed on 30 May 2006, the disclosure of which is hereby incorporated herein by reference in its entirety.

### BACKGROUND OF THE INVENTION

1. Technical Field

The present invention relates to a microphone type music accompaniment playing (karaoke) system having a background image selecting function and, more particularly, to a microphone type music accompaniment playing (karaoke) system that allows a user to select a background image while using music accompaniment playing equipment (karaoke) and displays the selected background image on a display panel.

2. Discussion of Related Art

Background images of general music accompaniment playing equipment (karaoke) include still and motion pictures. Once a user chooses a desired song to sing along with music accompaniment playing equipment (karaoke), background images are displayed irrespective of the song. In other words, background images are displayed on a display panel in the order that they are recorded in the music accompaniment playing equipment (karaoke), without considering the user's preference. Hence the conventional system has a problem in that it displays background images not matched to the played song and fails to fascinate users.

### SUMMARY OF THE INVENTION

It is accordingly an object of the present invention to provide a microphone type music accompaniment playing (karaoke) system with a background image selecting function that overcomes the problems with the conventional systems.

It is another object of the present to provide a microphone type music accompaniment playing (karaoke) system with a background image selecting function that displays background images matched to the song played.

It is further another object of the present invention to provide a microphone type music accompaniment playing (karaoke) system with a background image selecting function that allows a user to reserve or choose background images.

It is still further another object of the present invention to provide a microphone type music accompaniment playing (karaoke) system with a background image selecting function that fascinates users.

An exemplary embodiment of the present invention to achieve the objects provides a microphone type music accompaniment playing (karaoke) system including: a memory section for storing a plurality of still and motion pictures; a controller for, in Auto mode, combining the stored still and motion pictures of the memory section with each music accompaniment and sending the still or motion pictures selected in combination with the music accompaniment as a background image to an external display panel, or, in Select mode, sending both a music accompaniment signal and one of the still or motion pictures of the memory section as selected by a user as a background image to the external display panel.

The microphone type music accompaniment playing (karaoke) system includes: a mode selector for selecting either the Auto mode or the Select mode; and a numeric and control button pad for selecting a song in the Auto mode and both song and background image in the Select mode.

The background image includes still or motion pictures related to the user's selected song or an original singer of the song, the background image being automatically displayed in combination with the user's selected song or displayed by the user's choice. The background image includes theme-based images matched to the theme of the song, such as seasons, love, birthday, breakup or graduation, or genre-based images matched to the rhythm genre of the song, the background image being automatically displayed in combination with the user's selected song or displayed by the user's choice.

The memory section includes: at least one memory for storing the plurality of still and motion pictures; and a plurality of slots for insertion of a memory extension pack or a memory card storing the plurality of still and motion pictures.

Tags are assigned to the respective head sections of the still and motion pictures of the memory section, the information of the tags being used to select the background image or combine with the song. The controller includes an external communication means for providing additional still and motion pictures to the memory section.

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram showing a microphone type music accompaniment playing (karaoke) system with a background image selecting function;

FIG. 2 is an exploded perspective view of the microphone type music accompaniment playing (karaoke) system of FIG. 1; and

FIG. 3 is an external perspective view of the microphone type music accompaniment playing (karaoke) system of FIG. 1.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention. Like numbers refer to like element.

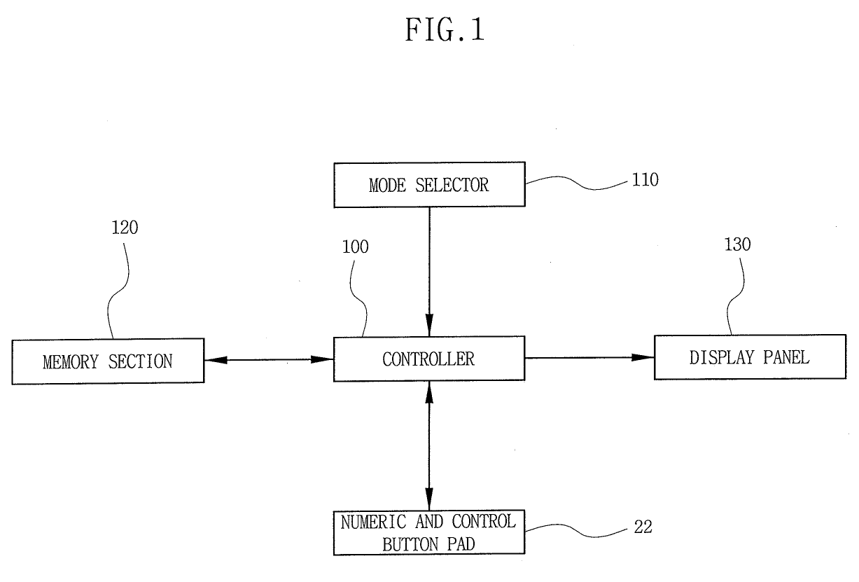

FIG. 1 is a block diagram of a microphone type music accompaniment playing (karaoke) system according to an embodiment of the present invention.

As illustrated in FIG. 1, the microphone type music accompaniment playing (karaoke) system according to an embodiment of the present invention includes a controller 100, a mode selector 110, a memory section 120, and a numeric and control button pad 22.

The controller 100 operates in at least two modes, for example, Auto mode and Select mode.

The Auto mode is activated when the user does not choose a background image for a predetermined period of time after selection of a song, or when he/she selects the Auto mode by use of the mode selector 110.

In Auto mode, the controller 100 combines the still and motion pictures stored the memory section 120 with the respective music accompaniments and outputs the selected pictures in combination with a music accompaniment to a display panel 130 as a background image.

The Select mode is enabled when the user chooses both song and background image, or when he/she chooses the Select mode by use of the mode selector 110.

In Select mode, the controller 100 sends the still and motion pictures of the memory section 120 as selected by the user as a background image together with a music accompaniment signal to the display panel 130. The display panel 130 includes an external display device such as TV, PC, etc.

The controller 100 may include audio/video signal transmit modules for sending the user's selected song, lyrics and background image to an external speaker or display panel 130. The speaker or display panel 130 in this case may have audio/video receive modules for receiving audio/video signals from the controller 100.

The operations of the controller 100 in Auto mode and Select mode are described in detail as follows.

In Auto mode, the controller 100 combines still and motion pictures stored in the memory section 120 with song numbers and sends the still and motion pictures of the song corresponding to a selected song number to the display panel 130 as a background image.

In an example of such a combination system, the key words contained in the song title or lyrics are combined with the stored background images, so the memory section 120 searches for the still or motion pictures related to given key words and sends the pictures as a background image. When the song title or lyrics contain ‘love's or breakup's, for example, the user can search for the still or motion pictures stored in the memory section 120 as related to the key words, ‘love’ or ‘breakup’ and choose the pictures in a sorting order or in a defined order as a background image.

In summary, the still or motion pictures of the memory section 120 are stored in different categories based on the original singers of the song, themes (e.g., love, seasons, breakup, birthday or graduation), rhythm genres (e.g., pop, rock, etc.) and song numbers, and combined with the user's selected song. The controller 100 may operate to automatically display the background image matched to the user's selected song on the display panel 130.

The controller 100, in Select mode, sends background image as selected by the user to the display panel 130. The user may choose still or motion pictures as a background image based on the theme according to the combination system in Auto mode, or randomly select the pictures as desired. The controller 100 may include a means for combining key words contained in the song title or lyrics with the stored background images and then making the user to search for still or motion pictures related to the given key words as a background image. The controller 100 may also allow the user to select one of the still or motion pictures sorted by theme or genre as a background image.

With too many still and motion pictures stored in the memory section 120 related to the user's selected song, the controller 100, in either Auto mode or Select mode, outputs background images in a sequential manner or repeatedly outputs several still or motion pictures preferred by the user.

When the user selects a theme and the number of songs irrespective of the mode, the controller 100 outputs music accompaniments and background images in the order of songs sorted by the user's preference for the theme.

As described above, as the user chooses a song in Auto mode or both song and background image in Select mode and presses the Start button of the karaoke system, the user's selected background image is displayed on the display panel while the user's selected music accompaniment is played. This increases the user's interest.

The memory section 120, which is for storing a plurality of still and motion pictures, may have at least one memory such as, for example, a main memory having at least one RAM, a storage memory having at least one ROM (e.g., flash memory), and a backup memory for data backup.

The memory section 120 may have a plurality of slots for insertion of memory extension packs or memory cards that store a plurality of still and motion pictures. With the memory extension packs or memory cards storing still and motion pictures, the memory section 120 may not have the main memory, storage memory, or backup memory.

The memory section 120 stores a variety of pictures of the original singers of a given song, information about the name of the singer, song number, genre, and theme-based background images.

The memory section 120 stores, in combination with the user's selected song, different still or motion pictures of the original singer of the song, so the images of the singer are displayed on the display panel 130. The memory section 120 also stores genre-based still or motion pictures that show dances and dance movements concerning the genre of the song. The memory section 120 also stores deferent still or motion pictures matched to the selected song based on the theme (e.g., seasons, love, breakup, birthday, etc.), so users can select some of the pictures as a desired background image.

Tags are assigned to the respective head sections of the still or motion pictures stored in the memory section 120 and used for the user's selection of a background image or combination of the pictures with the song.

The mode selector 110, which is for selecting either Auto mode or Select mode, has a select switch or button. The user can switch the mode with the mode selector 110 by pressing the buttons of the numeric and control button pad 22.

The numeric and control button pad 22, which is for selecting a song in Auto mode and both song and background image in Select mode, includes a set of buttons as provided on a remote control or another main body of general karaoke equipment.

The system may further include a display device such as LCD, so the user can check the entry of numbers and associated letters on the numeric and control button pad 22 to select a desired song number and background image.

The system may also have an external communication means such as a USB port to store additional still or motion pictures as desired by the user in the memory section 120. The user in this case can assign a tag to each head section of the additional still or motion pictures. Using the tag information, the user can choose a desired background image at the same time of selection of a song, so the system displays the background image matched to the user's song while playing the music accompaniment of the song.

The operation of selecting a background image in combination with a given song in Auto mode and the operation of enabling the user to choose a background image in Select mode as described above can be designed in accordance with the present invention and realized by a software program embodied in the controller 100.

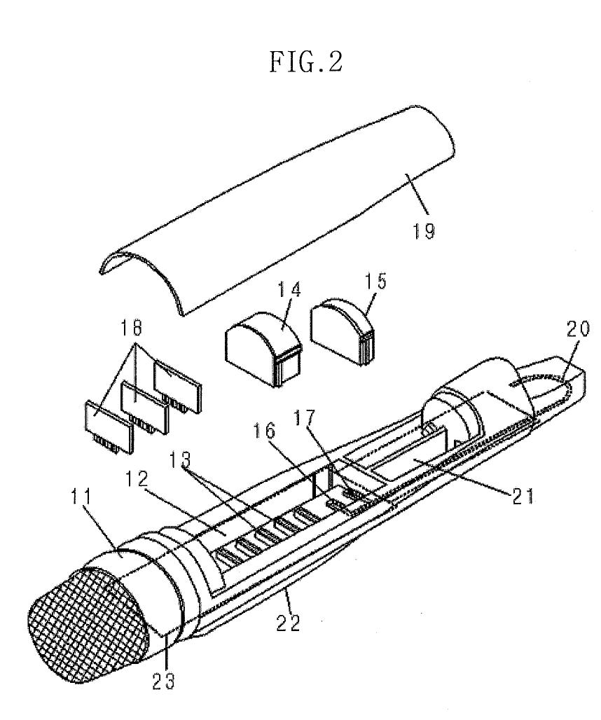

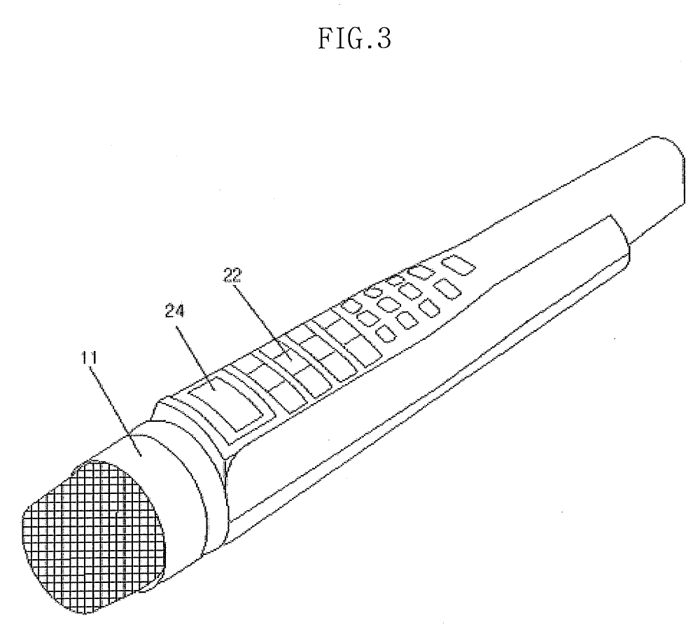

FIG. 2 is an exploded perspective view of the microphone type music accompaniment playing (karaoke) system of FIG. 1, and FIG. 3 is an external perspective view of the microphone type music accompaniment playing (karaoke) system of FIG. 1.

As illustrated in FIGS. 2 and 3, the microphone type music accompaniment playing (karaoke) system of the present invention includes an extension slot 13 on one inner side of main body 11 for insertion of a memory extension pack 18 storing background images. The slot 13 may be designed to receive a plurality of memory extension packs 18 storing still and motion pictures used as background images.

The storage of background images may be accomplished by mounting, as well as the memory extension pack 18, a memory chip such as RAM or ROM on a main substrate 23 or on the one side of a microphone.

The memory extension pack 18, the extension slot 13 for the memory extension pack 18, and the memory chip constitute the memory section 120.

Audio/video signal transmit modules 14 and 15 are provided on one inner side of the system adjacent to the memory section 120 to send the user's selected song, lyrics and background image to an external speaker and display panel 130. The system also has extension slots 16 and 17 for insertion of the audio/video signal transmit modules 14 and 15. The audio/video signal transmit modules 14 and 15 and the extension slots 16 and 17 constitute the controller 100.

For the entry of numbers and control to select song and background image, numeric and control button pad 22 is provided on one outer side of the main body 11 of the microphone type music accompaniment playing (karaoke) equipment. Using the numeric and control button pad 22, the user can choose a desired song number and a background image and select either Auto mode or Select mode.

The system also includes a display 24 such as LCD that enables the user to check the correctness of the entry of numbers and associated letters in selecting a background image, so the user can make it sure about the entry and choice of song number and background image.

The main body 11 of the microphone type music accompaniment playing (karaoke) equipment is constructed in either wire or wireless manner. For a wireless microphone, receiving spaces for batteries and audio/video signal transmit modules are provided on one inner side of the microphone.

Reference numeral 12 denotes a receiving space for the memory extension pack; reference numeral 19 denotes a cover; reference numeral 20 denotes an antenna wire for externally sending audio/video transmit signals; and reference numeral 21 denotes a receiving space for batteries built in the wireless microphone.

As described above, the present invention enables the user to select, in combination with the user's selected song, images of the original singer of the song and the song-related background images, thus fascinating users and greatly enhancing the demand for music accompaniment playing (karaoke) equipment.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

As described above, the present invention allows the user to select a background image based on the theme or genre of a given song and enjoy the desired background image while singing the song. The present invention also provides background images matched to the song played, fascinating users with increased pleasure and thereby increasing the demand for music accompaniment playing (karaoke) equipment.

What is claimed is:

1. A microphone type music accompaniment playing (karaoke) system comprising:
a memory section for storing a plurality of still and motion pictures;
a controller for, in Auto mode, combining the stored still and motion pictures of the memory section with each music accompaniment and sending the still or motion pictures selected in combination with the music accompaniment as a background image to an external display panel, or, in Select mode, sending both a music accompaniment signal and one of the still or motion pictures of the memory section as selected by a user as a background image to the external display panel.

2. The microphone type music accompaniment playing (karaoke) system as claimed in claim 1, further comprising:
a mode selector for selecting either the Auto mode or the Select mode.

3. The microphone type music accompaniment playing (karaoke) system as claimed in claim 2, further comprising:
a numeric and control button pad for selecting a song in the Auto mode and both song and background image in the Select mode.

4. The microphone type music accompaniment playing (karaoke) system as claimed in claim 1, wherein the background image includes still or motion pictures related to the user's selected song or an original singer of the song, the background image being automatically displayed in combination with the user's selected song or displayed by the user's choice.

5. The microphone type music accompaniment playing (karaoke) system as claimed in claim 1, wherein the background image includes theme-based images matched to the theme of the song, such as seasons, love, birthday, breakup or graduation, or genre-based images matched to the rhythm genre of the song, the background image being automatically displayed in combination with the user's selected song or displayed by the user's choice.

6. The microphone type music accompaniment playing (karaoke) system as claimed in claim 1, wherein the memory section includes at least one memory for storing the plurality of still and motion pictures.

7. The microphone type music accompaniment playing (karaoke) system as claimed in claim 1, wherein the memory section includes a plurality of slots for insertion of a memory extension pack or a memory card storing the plurality of still and motion pictures.

8. The microphone type music accompaniment playing (karaoke) system as claimed in claim 1, wherein tags are assigned to the respective head sections of the still and motion pictures of the memory section, the information of the tags being used to select the background image or combine with the song.

9. The microphone type music accompaniment playing (karaoke) system as claimed in claim 8, wherein the controller includes an external communication means for providing additional still and motion pictures to the memory section.
